(19) United States
(12) Patent Application Publication
(10) Pub. No.: US 2009/0322559 A1
(43) Pub. Date: Dec. 31, 2009

(54) WARNING SOUND DIRECTION DETECTING APPARATUS

(75) Inventors: Chia-Shin Yen, Taiwan (CN); Chien-Ming Wu, Taiwan (CN)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/375,688

(22) PCT Filed: Aug. 28, 2007
(86) PCT No.: PCT/JP2007/067104

§ 371 Date: Jan. 30, 2009

(30) Foreign Application Priority Data
Sep. 8, 2006 (CN) 200610129071.7

(51) Int. Cl. G08G 1/00

(52) U.S. Cl. 340/901

(57) ABSTRACT

A direction detecting apparatus is adapted for installation on a vehicle, and includes a first sound collecting unit, a second sound collecting unit, an identifying unit, a direction estimating unit, and a notifying unit. The first and second sound collecting units collect sounds from roads. The identifying unit identifies the types of the sounds collected by the first and second sound collecting units. The direction estimating unit determines whether a warning sound comes from the front when the sound type identified by the identifying unit is a warning sound. The direction estimating unit estimates the direction of the warning sound when the warning sound comes from the front, and estimates a lane in which the warning sound is located when the warning sound comes from behind. The notifying unit is for providing notification of the estimation result of the direction estimating unit.

### TECHNICAL FIELD

The invention relates to a detecting apparatus, and more particularly to a direction detecting apparatus.

### BACKGROUND ART

As sound insulation in vehicles gets increasingly better, and with many drivers having the habit of playing music while driving, it is increasingly difficult for the drivers to hear outside sounds. According to research findings, it is shown that when a vehicle runs at high speed (approximately 100 km/hr), or when music is played at high volume (approximately 76 decibels audible, dBA) in the vehicle, the driver will be unable to hear warning sounds from an emergency vehicle (e.g., ambulance and fire engine).

Since the driver is unable to clearly hear these outside sounds, when an emergency vehicle approaches, accidents may easily occur due to the driver's inability to dodge in time. In order to ensure the safety of the driver, notifying systems capable of identifying warning sounds of emergency vehicles to warn the driver are being taken more and more seriously.

For the driver, the emergency vehicle notifying system must not be limited to the location of use. When an emergency vehicle approaches from the front, since the driver can easily see it, it is sufficient only to know the direction of the emergency vehicle. On the other hand, when the emergency vehicle approaches from behind, since the driver can hardly see it, it is necessary to know the lane in which the emergency vehicle is located, so as to immediately make way for the emergency vehicle to pass in case the two vehicles are in the same lane.

Referring to FIG. 1, JP 11-48886 discloses an in-vehicle emergency vehicle notifying system to display the approach of emergency vehicles.

The in-vehicle emergency vehicle notifying system comprises an exterior sound collecting device 31, a warning sound detecting device 32, a computing device 33, and a notifying device 34. The exterior sound collecting device 31 includes four microphones (not shown) respectively placed in four directions. Each of the microphones collects sounds outside of the vehicle. The warning sound detecting device 32 detects whether there is a warning sound from an emergency vehicle among the sounds collected by the exterior sound collecting device 31. The computing device 33 computes the distance, direction and type of the emergency vehicle based on the warning sound detected by the warning sound detecting device 32. The notifying device 34 signals the location and the type of the emergency vehicle based on the computation result of the computing device 33. Here, the direction of the emergency vehicle is computed based on energy differences among the warning sounds collected by the four microphones.

The in-vehicle emergency vehicle notifying system can provide notification no matter where the vehicle is. However, the conventional in-vehicle emergency vehicle notifying system computes the direction of the emergency vehicle based on the energy differences among the warning sounds collected by a plurality of microphones placed at different locations. Referring to FIG. 2, when a vehicle 35 and an emergency vehicle 36 approach an intersection but are located on different roads, since nearby buildings or other obstacles will block and reflect the warning sounds of the emergency vehicle 36, the in-vehicle emergency vehicle notifying system may receive the warning sounds from a path of reflection, resulting in erroneous judgment of the direction. In addition, when the emergency vehicle approaches from behind, the in-vehicle emergency vehicle notifying system is unable to display the lane in which the emergency vehicle is located.

Other than the in-vehicle emergency vehicle notifying system, there is also an emergency vehicle notifying system for installation on roads.

Referring to FIG. 3 and FIG. 4, JP 2000-20885 discloses a traffic information displaying system, adapted for use on a straight road, and displaying the lane in which an emergency vehicle is located. A three-lane road is given as an example hereinbelow to illustrate the traffic information displaying system.

The traffic information displaying system comprises three microphones 11, a display control device 12 and a traffic information display board 13. The three microphones 11 respectively collect sounds from the three lanes. The display control device 12 includes three warning sound detecting units 121, three frequency shift component detecting units 122, three movement direction determining units 123, a lane determining unit 124, and a display board controlling unit 125. The traffic information display board 13 is installed on the road, and includes three lane display units 131 that respectively correspond to the three lanes.

The three warning sound detecting units 121 respectively detect whether there are warning sounds from an emergency vehicle 14 among the sounds collected by the three microphones 11. The three frequency shift component detecting units 122 respectively detect frequency shift components caused by the movement of the emergency vehicle 14 based on the warning sounds detected by the three warning sound detecting units 121. The three movement direction determining units 123 respectively determine whether the emergency vehicle 14 is approaching based on the frequency shift components detected by the frequency shift component detecting units 122. The lane determining unit 124 determines the lane in which the emergency vehicle 14 is located based on the detection results of the three warning sound detecting units 121 and the three frequency shift component detecting units 122. The display board controlling unit 125 controls the traffic information display board 13 based on the determination results of the three movement direction determining units 123 and the lane determining unit 124. When the emergency vehicle 14 approaches, the traffic information display board 13 displays “emergency vehicle approaching”, and the lane displaying unit 131 that corresponds to the lane in which the emergency vehicle 14 is located is also lit up.

Referring to FIG. 5 and FIG. 6, JP 2001-67587 discloses an emergency vehicle safe pass apparatus adapted for use at an intersection so as to allow a smooth passing of an emergency vehicle 26 through the intersection. An intersection that connects four roads, each of which is set up with a traffic light 25, is given as an example hereinbelow to illustrate the emergency vehicle safe pass apparatus.

The emergency vehicle safe pass apparatus includes four uni-directional microphones 21, a sound identifying circuit 22, a control circuit 23 and four displays 24. The four microphones 21 respectively collect sounds from the four roads. The four displays 24 are respectively installed at locations on the four roads that are close to the intersection. The sound identifying circuit 22 identifies whether there is a warning sound of the emergency vehicle 26 among the sounds collected by the microphones 21. The control circuit 23 controls the displays 24 and the traffic lights 25 based on the identification results of the sound identifying circuit 22. When the emergency vehicle 26 approaches the intersection, the emergency vehicle safe pass apparatus displays a warning signal and changes the phase of the traffic lights.

The emergency vehicle notifying system mounted on roads can only be functional at locations mounted with the system, and is therefore imposed with location-of-use limitations. The conventional traffic information displaying system is suitable for use on a straight road. Although the lane in which the emergency vehicle is located can be displayed, the driver cannot know whether the emergency vehicle is ahead or behind. As a result, the driver cannot determine whether there is a need to yield the lane. In addition, though the conventional emergency vehicle safe pass apparatus is suitable for use at an intersection and capable of displaying that there is an emergency vehicle approaching, the driver still cannot know whether the emergency vehicle approaches from behind.

### DISCLOSURE OF INVENTION

Therefore, the object of the present invention is to provide an in-vehicle direction detecting apparatus that is capable of providing notification regarding the direction or located lane of a warning sound at any location.

Accordingly, the direction detecting apparatus of the present invention is suitable for installation on a vehicle, and comprises a first sound collecting unit, a second sound collecting unit, an identifying unit, a direction estimating unit, and a notifying unit.

The first sound collecting unit is placed on the front side of the vehicle, and collects sounds from roads.

The second sound collecting unit is placed on the rear side of the vehicle, and collects the sounds from the roads.

The identifying unit identifies the types of the sounds collected by the first and second sound collecting units.

The direction estimating unit determines, upon identification by the identifying unit that a sound is a warning sound, whether the warning sound comes from the front. The direction estimating unit estimates the direction of the warning sound when the warning sound comes from the front, and estimates the lane in which the warning sound is located when the warning sound comes from behind.

The notifying unit is for providing notification of the estimation result of the direction estimating unit.

### BRIEF DESCRIPTION OF DRAWINGS

The aforesaid and other technical contents, features and advantages of the present invention will be clearly presented in the following detailed description of two preferred embodiments with reference to the accompanying drawings, of which:

FIG. 1 is a block diagram, illustrating a conventional in-vehicle emergency vehicle notifying system;

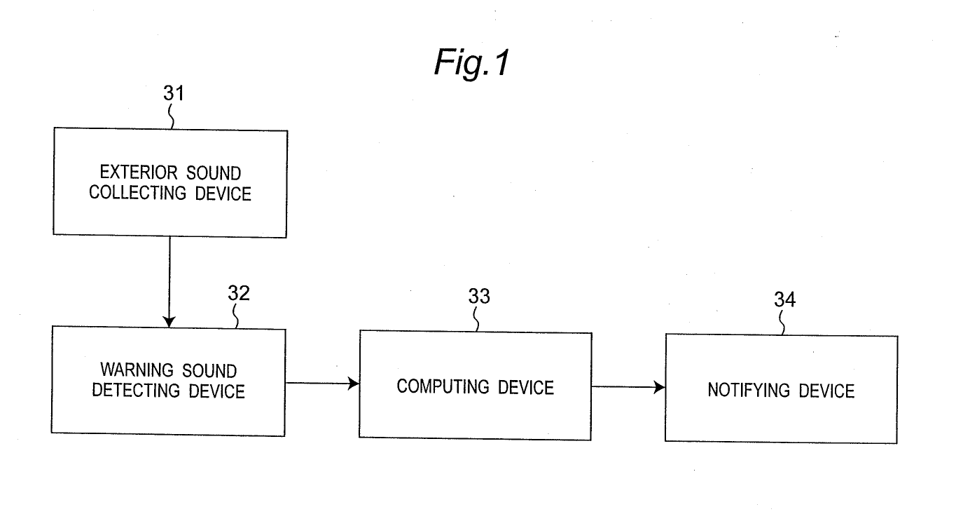

FIG. 2 is a schematic diagram, illustrating a situation where the in-vehicle emergency vehicle notifying system receives a warning sound of an emergency vehicle from a path of reflection;

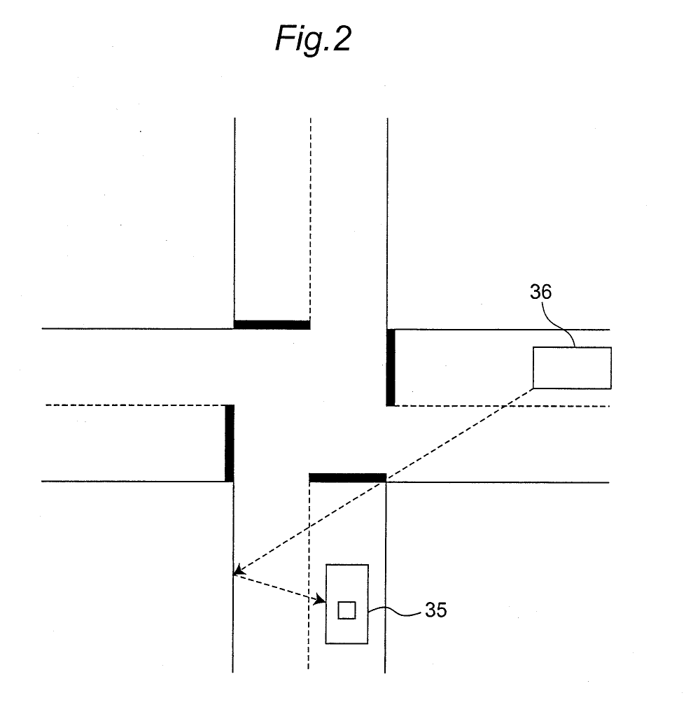

FIG. 3 is a schematic diagram, illustrating a situation where a conventional traffic information displaying system is installed on a road;

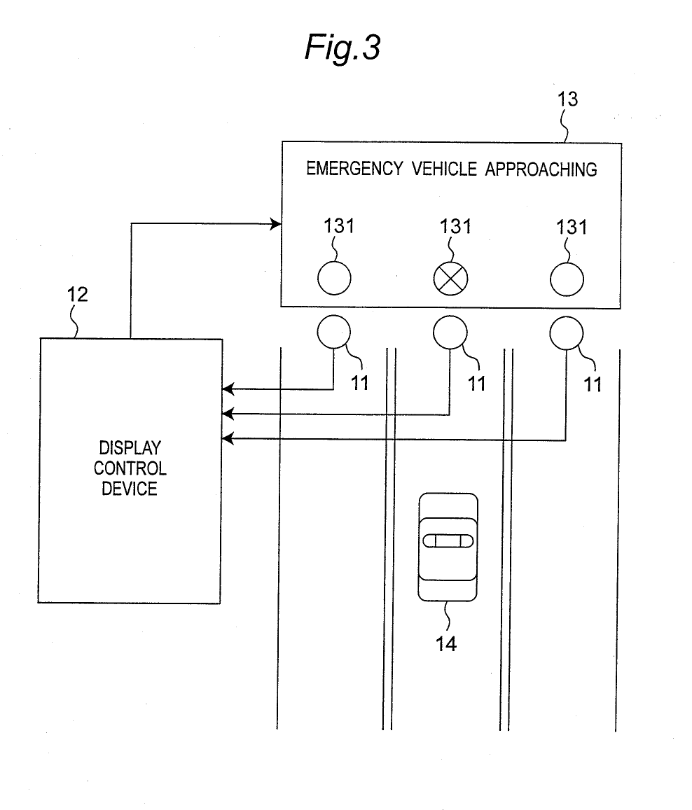

FIG. 4 is a block diagram, illustrating the traffic information displaying system;

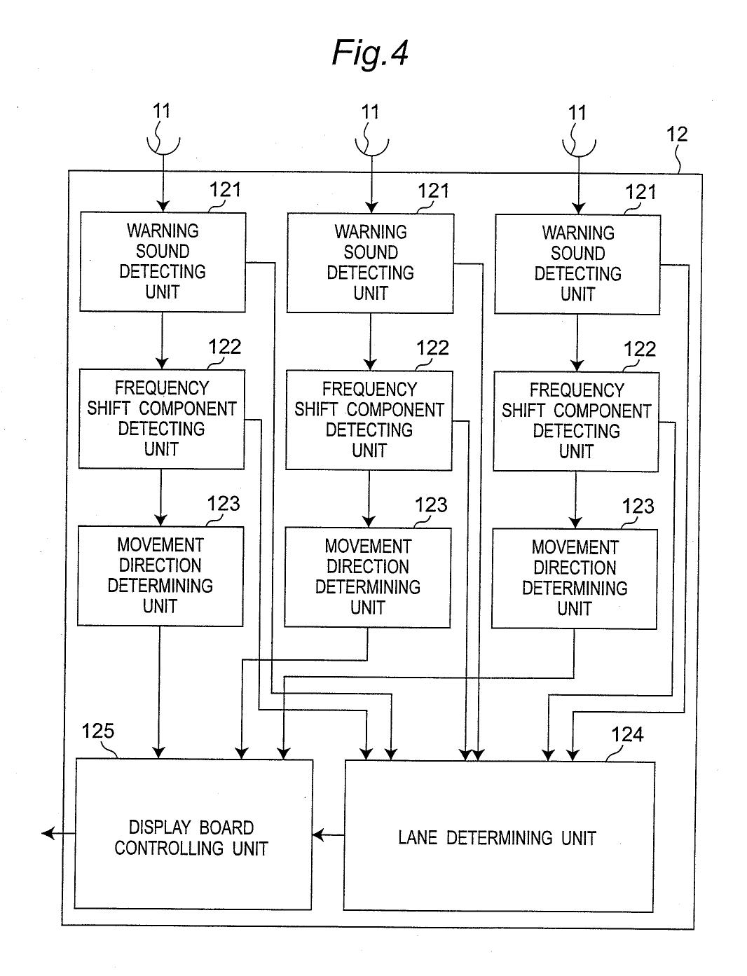

FIG. 5 is a schematic diagram, illustrating a situation where a conventional emergency vehicle safe pass apparatus is installed on a road;

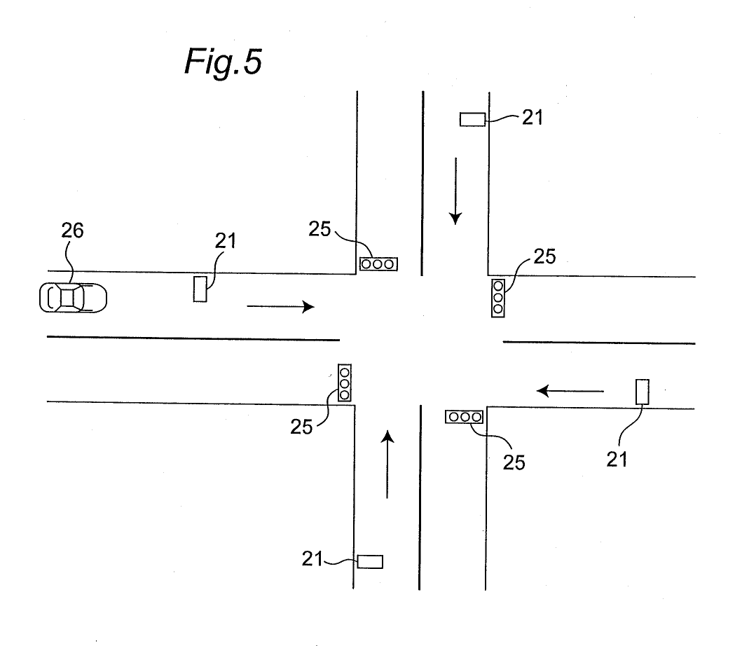

FIG. 6 is a block diagram, illustrating the emergency vehicle safe pass apparatus;

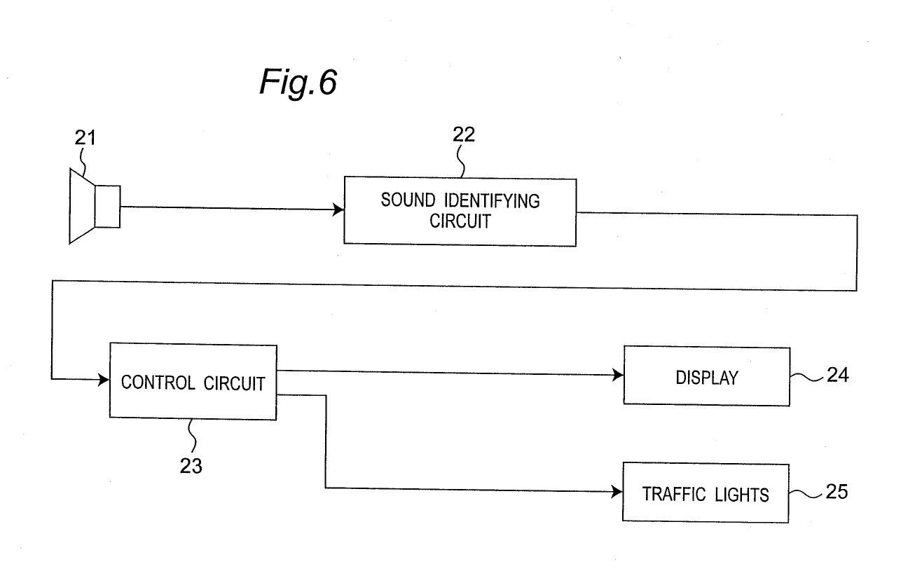

FIG. 7 is a block diagram, illustrating the first preferred embodiment of a direction detecting apparatus according to the present invention;

FIG. 8 is a schematic diagram, illustrating a situation where the first preferred embodiment is installed on a vehicle;

FIG. 9 is a flow chart, illustrating the operation of the first preferred embodiment;

FIG. 10 is a block diagram, illustrating the second preferred embodiment of a direction detecting apparatus according to the present invention;

FIG. 11 is a flow chart, illustrating the operation of the second preferred embodiment;

FIG. 12 is a schematic diagram, illustrating a situation where a sound replicating apparatus is installed on a road;

FIG. 13 is a block diagram, illustrating the sound replicating apparatus; and

FIG. 14 is a flow chart, illustrating the operation of the sound replicating apparatus.

### BEST MODE FOR CARRYING OUT THE INVENTION

Before the present invention is described in greater detail, it should be noted herein that like elements are denoted by the same reference numbers throughout the following disclosure.

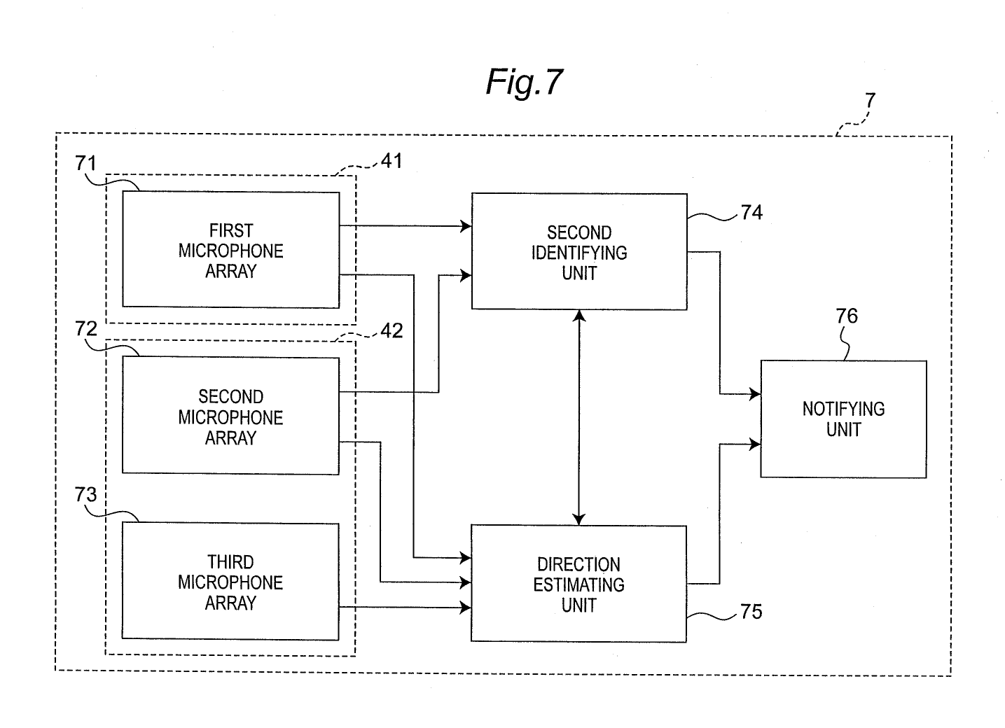

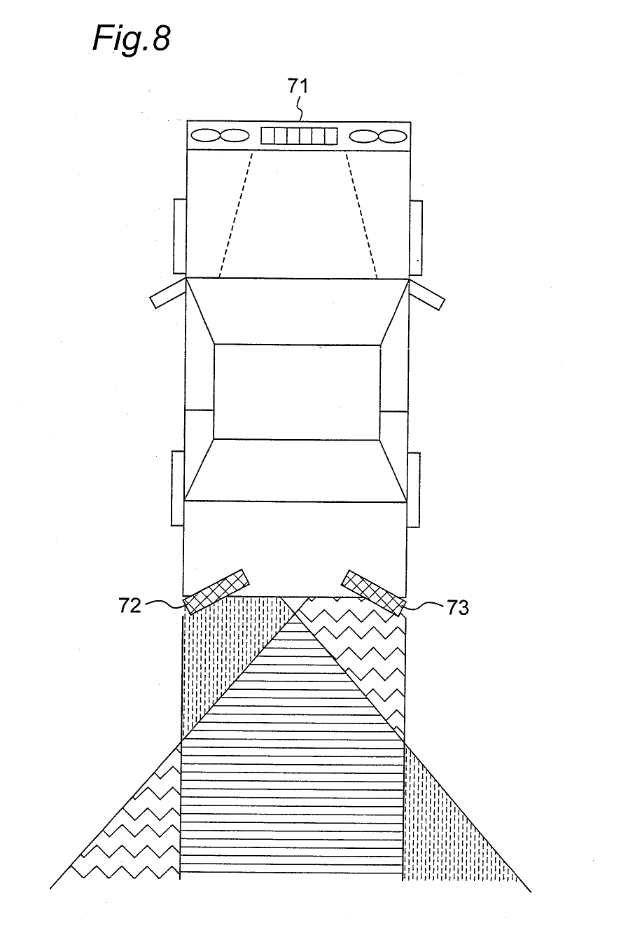

With reference to FIG. 7 and FIG. 8, the first preferred embodiment of a direction detecting apparatus 7 according to the present invention comprises a first sound collecting unit 41, a second sound collecting unit 42, a second identifying unit 74, a direction estimating unit 75, and a notifying unit 76.

The first sound collecting unit 41 includes a first microphone array 71, and the second sound collecting unit 42 includes a second microphone array 72 and a third microphone array 73. The first to third microphone arrays 71-73 are respectively placed on the front side, the left rear side and the right rear side of the vehicle. In addition, each of the microphone arrays 71-73 has a plurality of microphones.

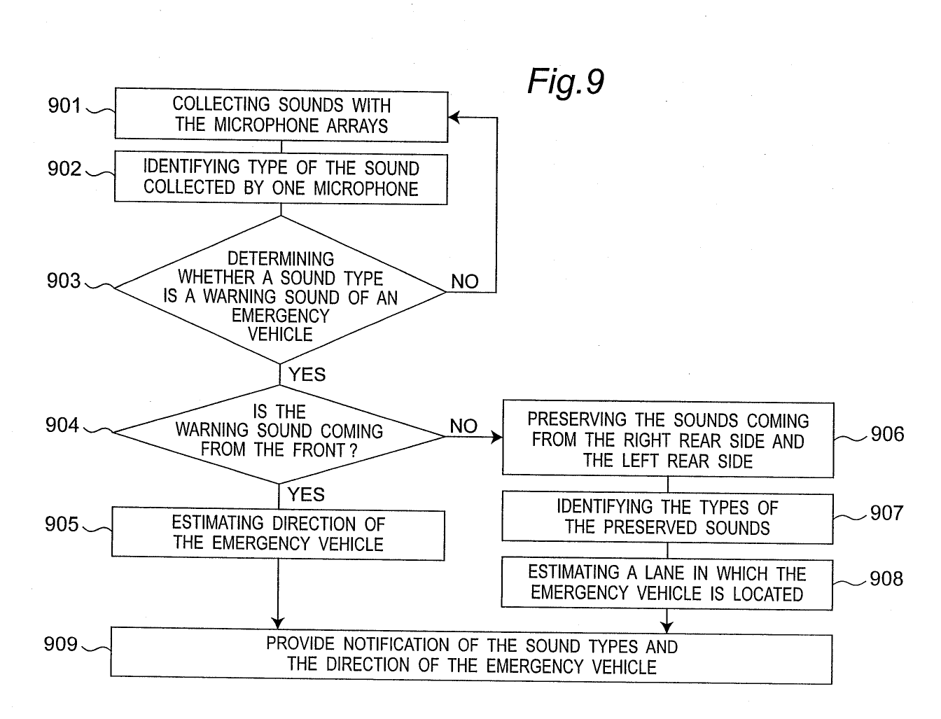

With reference to FIG. 7 and FIG. 9, the method used in this embodiment comprises the following steps:

In step 901, the microphones of the first to third microphone arrays 71-73 collect sounds from the roads.

In step 902, the second identifying unit 74 identifies a type of sound collected by one of the microphones of the microphone arrays 71-73.

In this embodiment, the second identifying unit 74 identifies the type of sound collected by one of the microphones of the first microphone array 71.

In step 903, the direction estimating unit 75 determines whether the sound collected by the microphone is a warning sound of an emergency vehicle based on the sound type identified by the second identifying unit 74. If yes, the process jumps to step 904. If no, the process jumps back to step 901.

In step 904, the direction estimating unit 75 determines whether the warning sound comes from the front based on the energy magnitudes of the sounds collected by one of the microphones of the first microphone array 71 and by one of the microphones of the second and third microphone arrays 72, 73. If yes, the process jumps to step 905. If no, the process jumps to step 906.

In this embodiment, the direction estimating unit 75 determines based on the energy magnitudes of the sounds collected by one of the microphones of the first microphone array 71 and by one of the microphones of the second microphone array 72.

In step 905, the direction estimating unit 75 estimates the direction of the emergency vehicle based on the sounds collected by the first microphone array 71. The process then jumps to step 909.

In this embodiment, the direction estimating unit 75 uses Multiple Signal Classification (MUSIC) algorithm to estimate the direction of the emergency vehicle. However, other direction of arrival (DoA) detection algorithms, such as Cross-Power Spectrum Phase (CPSP), Cross Correlation, Beam Forming, etc., can also be used, and the invention is not limited in this aspect.

In step 906, the direction estimating unit 75 preserves the portions of the sounds collected by the second microphone array 72 that come from the direct rear side and the right rear side of the vehicle, and preserves the portions of the sounds collected by the third microphone array 73 that come from the direct rear side and the left rear side of the vehicle.

In this embodiment, the direction estimating unit 75 uses the Beam Forming algorithm, and adjusts a delay time parameter thereof to select a directional range of the to-be-preserved sounds. However, the Multiple Signal Classification algorithm can also be used to estimate the direction of the sounds, and preserves sounds when the sound direction falls within the directional range of the to-be-preserved sounds, and the invention is not limited in this aspect. It should be noted herein that two directional microphones can also be used, with one collecting the sounds coming from the direct rear side and the right rear side of the vehicle, and the other one collecting the sounds coming from the direct rear side and the left rear side of the vehicle, thereby avoiding the need to collect the sounds coming from all directions and then preserve the desirable portions. The detailed method of practice is described hereinbelow in the second preferred embodiment.

In step 907, the second identifying unit 74 identifies the types of the sounds preserved by the direction estimating unit 75.

In step 908, the direction estimating unit 75 determines the direction of the emergency vehicle based on the sound types identified by the second identifying unit 74. When the sounds coming from the direct rear side and the right rear side of the vehicle and the sounds coming from the direct rear side and the left rear side of the vehicle are all warning sounds, then the emergency vehicle is located in the same lane as the vehicle. When only the sounds coming from the direct rear side and the right rear side of the vehicle are warning sounds, then the emergency vehicle is located in a lane to the right side of the vehicle. In addition, when only the sounds coming from the direct rear side and the left rear side of the vehicle are warning sounds, the emergency vehicle is located in a lane to the left side of the vehicle.

In step 909, the notifying unit 76 notifies the driver of the sound types identified by the second identifying unit 74, and the direction of the emergency vehicle estimated by the direction estimating unit 75.

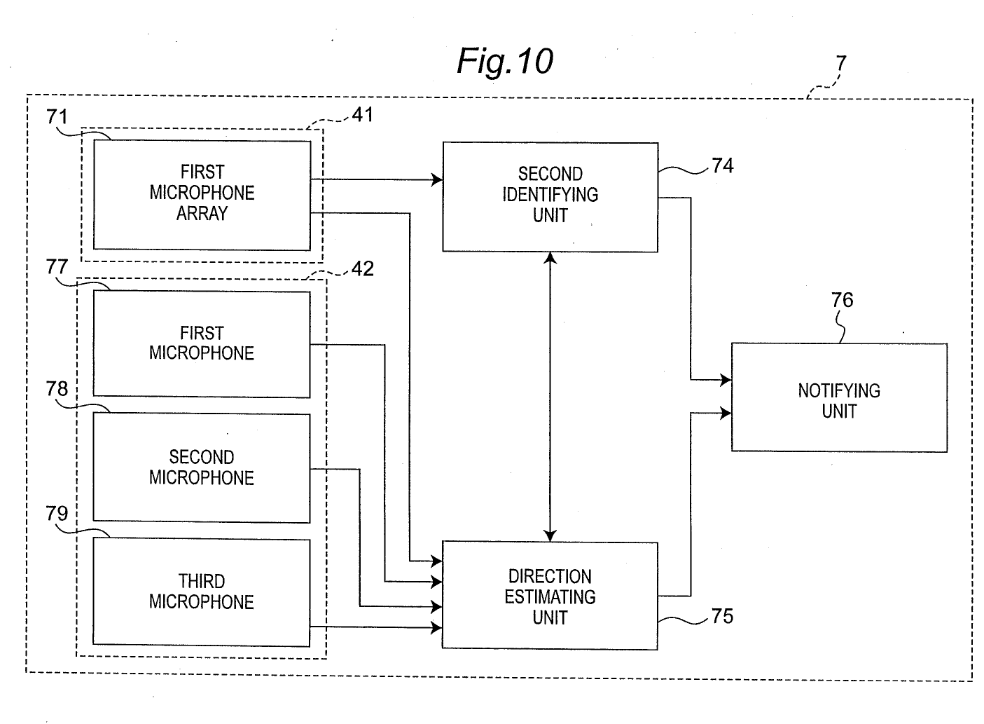

With reference to FIG. 10, the second preferred embodiment of the direction detecting apparatus 7 according to the present invention comprises a first sound collecting unit 41, a second sound collecting unit 42, a second identifying unit 74, a direction estimating unit 75, and a notifying unit 76.

The first sound collecting unit 41 includes a first microphone array 71, and the second sound collecting unit 42 includes a first microphone 77, a second microphone 78, and a third microphone 79. The first microphone array 71 is placed on the front side of the vehicle, and has a plurality of microphones. The first to third microphones 77-79 are respectively placed on the left rear side, the right rear side, and at any location of the rear side of the vehicle, and the first and second microphones 77, 78 are directional microphones.

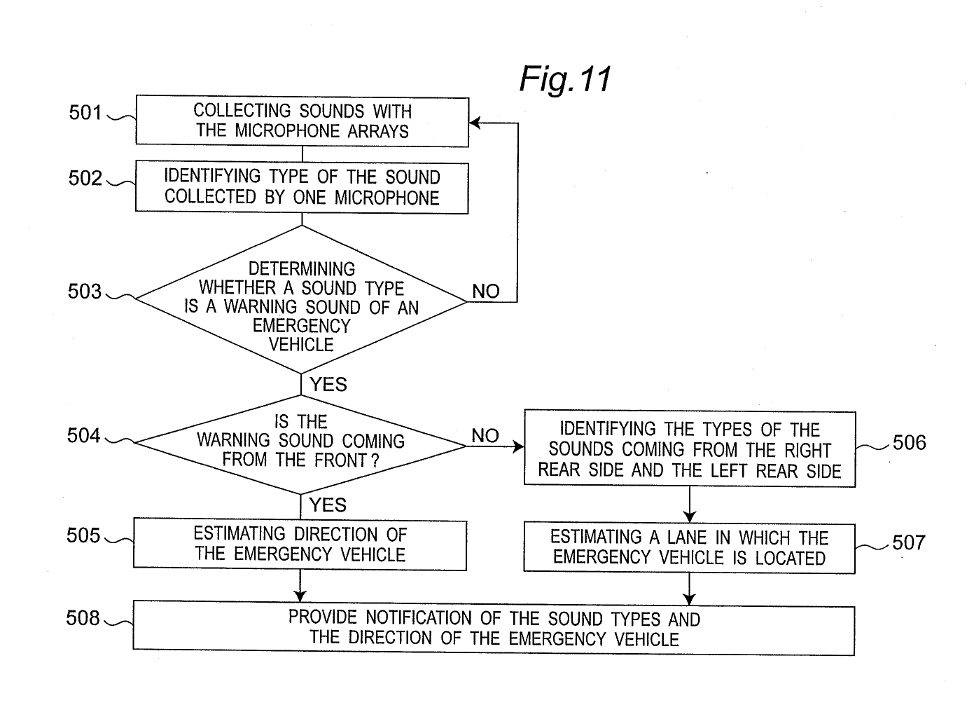

With reference to FIG. 10 and FIG. 11, the method used in this embodiment comprises the following steps:

In step 501, the microphones of the first microphone array 71 and the third microphone 79 collect sounds from the roads. The first microphone 77 collects sounds from the direct rear side and the right rear side of the vehicle, and the second microphone 78 collects sounds from the direct rear side and the left rear side of the vehicle.

In step 502, the second identifying unit 74 identifies a type of sound collected by one of the microphones of the first microphone array 71 and the third microphone 79.

In this embodiment, the second identifying unit 74 identifies the type of sound collected by one of the microphones of the first microphone array 71.

In step 503, the direction estimating unit 75 determines whether the sound collected by the microphone is a warning sound of an emergency vehicle based on the sound type identified by the second identifying unit 74. If yes, the process jumps to step 504. If no, the process jumps back to step 501.

In step 504, the direction estimating unit 75 determines whether the warning sound comes from the front based on the energy magnitudes of the sounds collected by one of the microphones of the first microphone array 71 and by the third microphone 79. If yes, the process jumps to step 505. If no, the process jumps to step 506.

In step 505, the direction estimating unit 75 estimates the direction of the emergency vehicle based on the sounds collected by the first microphone array 71. The process then jumps to step 508.

In this embodiment, the direction estimating unit 75 uses Multiple Signal Classification algorithm to estimate the direction of the emergency vehicle. However, other direction of arrival detection algorithms, such as Cross-Power Spectrum Phase, Cross Correlation, Beam Forming, etc., can also be used, and the invention is not limited in this aspect.

In step 506, the second identifying unit 74 identifies the types of the sounds collected by the first microphone 77 and the second microphone 78.

In step 507, the direction estimating unit 75 determines the direction of the emergency vehicle based on the sound types identified by the second identifying unit 74. When the sounds collected by the first microphone 77 and the second microphone 78 are both warning sounds (i.e., the sounds from the direct rear side and the right rear side of the vehicle, and the sounds from the direct rear side and the left rear side of the vehicle are all warning sounds), the emergency vehicle is located in the same lane with the vehicle. When only the sound collected by the first microphone 77 is a warning sound (i.e., only the sounds coming from the direct rear side and the right rear side of the vehicle are warning sounds), the emergency vehicle is located in a lane to the right side of the vehicle. In addition, when only the sound collected by the second microphone 78 is a warning sound (i.e., only the sounds coming from the direct rear side and the left rear side of the vehicle are warning sounds), the emergency vehicle is located in a lane to the left side of the vehicle.

In step 508, the notifying unit 76 notifies the driver of the sound types identified by the second identifying unit 74, and the direction of the emergency vehicle estimated by the direction estimating unit 75.

It should be noted herein that, in step 904 and step 504, whether the warning sound comes from the front is determined based on the energy magnitudes of collected sounds. However, whether the warning sound comes from the front can also be determined based on a time difference among the collected sounds.

However, the direction detecting apparatus 7 of the present invention is the same as the conventional emergency vehicle notifying system installed on a vehicle in that erroneous judgment of the direction might occur when the warning sound is collected from a path of reflection.

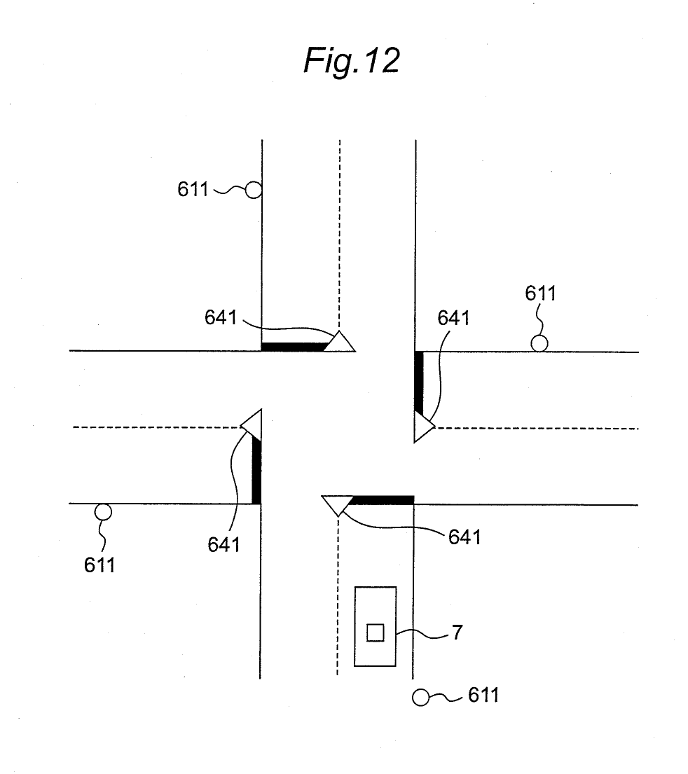

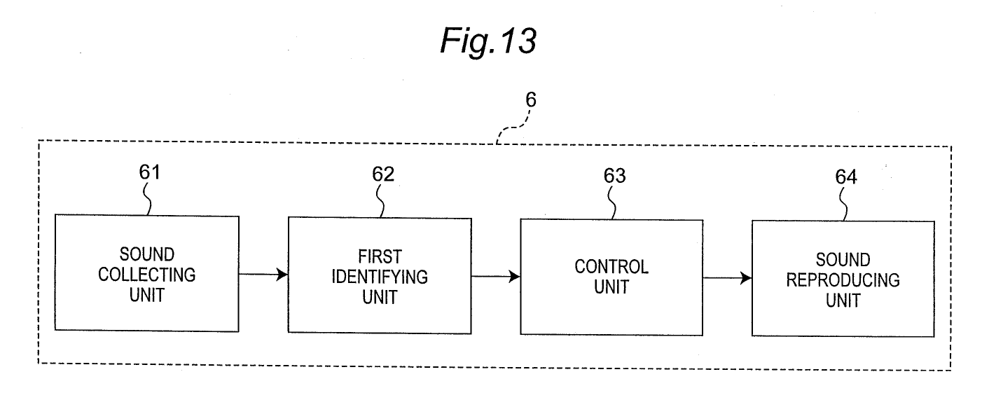

With reference to FIG. 12 and FIG. 13, the direction detecting apparatus 7 of the present invention can cooperate with a sound replicating apparatus 6 to solve the abovementioned problem. The sound replicating apparatus 6 is installed at an intersection that connects M roads, where M is not smaller than 2 (FIG. 12 illustrates a situation where M=4).

The sound replicating apparatus 6 comprises a sound collecting unit 61, a first identifying unit 62, a control unit 63, and a sound reproducing unit 64.

The sound collecting unit 61 has M microphones 611 that respectively collect sounds from the M roads. The sound reproducing unit 64 has M speakers 641. Each of the speakers 641 is placed at a location of a corresponding road close to the intersection, corresponds to the microphone 611 that collects the sounds from the corresponding road, and is capable of reproducing sounds towards the rest of the roads.

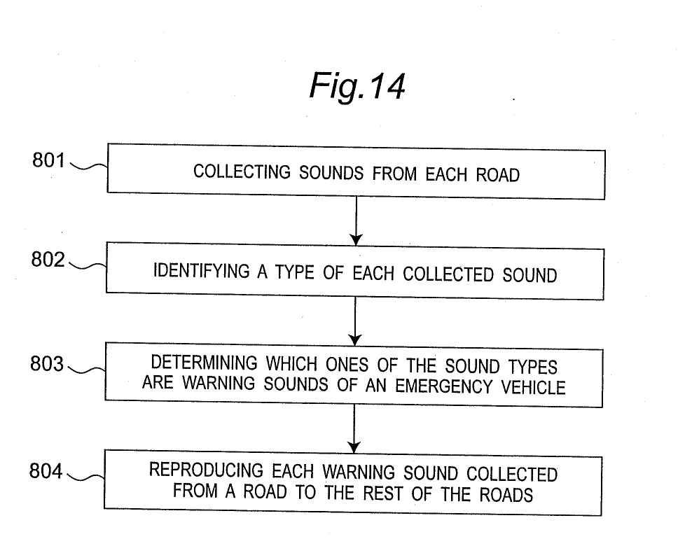

With reference to FIG. 12, FIG. 13 and FIG. 14, the method used by the sound replicating apparatus 6 comprises the following steps:

In step 801, the M microphones 611 of the sound collecting unit 61 respectively collect the sounds from the M roads.

In step 802, the first identifying unit 62 identifies the type of the sound collected by each of the microphones 611.

In step 803, the control unit 63 determines whether the sound collected by each of the microphones 611 is a warning sound of an emergency vehicle based on the sound type identified by the first identifying unit 62.

In step 804, the control unit 63 instructs the speaker(s) 641 to reproduce the warning sound collected by the corresponding microphone(s) 611, and outputs the warning sound type and the road in which the emergency vehicle is located, so as to control traffic lights.

It should be noted herein that, after the first identifying unit 62 identifies the type of the sound collected by each of the microphones 611 in step 802, step 803 is executed. However, the first identifying unit 62 can also identify the type of the sound collected by one of the microphones 611, and the steps 803 and 804 are executed immediately. Subsequently, the steps 802-804 are repeated to process the sound collected by another one of the microphones 611.

With the sound replicating apparatus 6 reproducing each of the warning sounds collected from one road to the rest of the roads at an intersection, the direction detecting apparatus 7 will not receive warning sounds from paths of reflection, and thus will not mistakenly determine the direction of an emergency vehicle when the emergency vehicle approaches from the front.

In sum, since the direction detecting apparatus 7 according to the present invention is installed on a vehicle, notification can be received no matter where the vehicle location is. In addition, based on the sounds coming from the direct rear side and the right rear side of the vehicle, and on the sounds coming from the direct rear side and the left rear side of the vehicle, when an emergency vehicle approaches from behind, it can be determined whether the two vehicles are located in the same lane. Therefore, the objects of the present invention are indeed achieved.

However, the aforementioned are merely preferred embodiments of the present invention, and should not be taken to limit the scope of implementation of the present invention. In other words, any simple equivalent variation and modification based on the claims and the contents of the specification of the present invention are included within the scope of the present invention.

### INDUSTRIAL APPLICABILITY

The present invention can be applied to a direction detecting apparatus.

1. A direction detecting apparatus adapted for installation on a vehicle, and comprising:
a first sound collecting unit placed on the front side of the vehicle, and collecting sounds from a road;
a second sound collecting unit placed on the rear side of the vehicle, and collecting the sounds from the road;
an identifying unit identifying the types of the sounds collected by said first and second sound collecting units;
a direction estimating unit determining, upon identification by said identifying unit that a sound is a warning sound, whether the warning sound comes from the front, said direction estimating unit further estimating the direction of the warning sound when the warning sound comes from the front, and estimating a lane in which the warning sound is located when the warning sound comes from behind; and
a notifying unit for providing notification of the estimation result of said direction estimating unit.

2. The direction detecting apparatus as claimed in claim 1, wherein said first sound collecting unit includes a first microphone array, and said second sound collecting unit includes a second microphone array placed on the left rear side of the vehicle, and a third microphone array placed on the right rear side of the vehicle, each of said microphone arrays including a plurality of microphones, and each of said microphones collecting the sounds from the road.

3. The direction detecting apparatus as claimed in claim 2, wherein said identifying unit identifies the type of the sound collected by one of said microphones of said first and second sound collecting units.

4. The direction detecting apparatus as claimed in claim 2, wherein said direction estimating unit determines whether the warning sound comes from the front based on the energy magnitudes of the sounds collected by one of said microphones of said first sound collecting unit and by one of said microphones of said second sound collecting unit.

5. The direction detecting apparatus as claimed in claim 2, wherein said direction estimating unit determines whether the warning sound comes from the front based on time difference between the sounds collected by one of said microphones of said first sound collecting unit and by one of said microphones of said second sound collecting unit.

6. The direction detecting apparatus as claimed in claim 2, wherein when the warning sound comes from the front, said direction estimating unit estimates the direction of the warning sound based on the sounds collected by said first microphone array.

7. The direction detecting apparatus as claimed in claim 2, wherein when the warning sound comes from behind, said direction estimating unit preserves the portions of the sounds collected by said second microphone array coming from the direct rear side and the right rear side of the vehicle, and preserves the portions of the sounds collected by said third microphone array coming from the direct rear side and the left rear side of the vehicle, said identifying unit further identifying the types of the sounds preserved by said direction estimating unit so that said direction estimating unit determines the lane in which the warning sound is located, the warning sound being located in the same lane as the vehicle when the sounds coming from the direct rear side and the right rear side of the vehicle and those coming from the direct rear side and the left rear side of the vehicle are all warning sounds, the warning sound being located in a lane to the right side of the vehicle when only the sounds coming from the direct rear side and the right rear side of the vehicle are warning sounds, the warning sound being located in a lane to the left side of the vehicle when only the sounds coming from the direct rear side and the left rear side of the vehicle are warning sounds.

8. The direction detecting apparatus as claimed in claim 1, wherein said notifying unit further provides notification of the sound types identified by said identifying unit.

9. The direction detecting apparatus as claimed in claim 1, wherein said first sound collecting unit includes a first microphone array that has a plurality of microphones, and said second sound collecting unit includes a first microphone that is placed on the left rear side of the vehicle, a second microphone that is placed on the right rear side of the vehicle, and a third microphone that is placed at any location on the rear side of the vehicle, said microphones of said first sound collecting unit and said third microphone collecting the sounds from the road, said first microphone being a directional microphone used for collecting the sounds from the direct rear side and the right rear side of the vehicle, and said second microphone also being a directional microphone used for collecting sounds from the direct rear side and the left rear side of the vehicle.

10. The direction detecting apparatus as claimed in claim 9, wherein said identifying unit identifies the type of the sound collected by one of said microphones of said first microphone array and said third microphone.

11. The direction detecting apparatus as claimed in claim 9, wherein said direction estimating unit determines whether the warning sound comes from the front based on the energy magnitudes of the sounds collected by one of said microphones of said first microphone array and by said third microphone.

12. The direction detecting apparatus as claimed in claim 9, wherein said direction estimating unit determines whether the warning sound comes from the front based on time difference between the sounds collected by one of said microphones of said first microphone array and by said third microphone.

13. The direction detecting apparatus as claimed in claim 9, wherein when the warning sound comes from the front, said direction estimating unit estimates the direction of the warning sound based on the sounds collected by said first microphone array.

14. The direction detecting apparatus as claimed in claim 9, wherein when the warning sound comes from behind, said identifying unit further identifies the types of the sounds collected by said first microphone and said second microphone so that said direction estimating unit determines the lane in which the warning sound is located, the warning sound being located in the same lane as the vehicle when the sounds collected by said first microphone and said second microphone are all warning sounds, the warning sound being located in a lane to the right side of the vehicle when only the sound collected by said first microphone is a warning sound, and the warning sound being located in a lane to the left side of the vehicle when only the sound collected by said second microphone is a warning sound.
